(19) United States
(12) Patent Application Publication
(10) Pub. No.: US 2025/0093242 A1
(43) Pub. Date: Mar. 20, 2025

(54) METHOD FOR PRETREATMENT OF BIOLOGICAL SAMPLE FOR RADIONUCLIDE MEASUREMENT USING GAMMA-SPECTROSCOPY

(71) Applicant: South China Sea Environment Monitoring Center, State Oceanic Administration (SOA) of PR China, Guangzhou (CN)

(72) Inventors: Peng Zhou, Guangzhou (CN); Li Zhao, Guangzhou (CN); Yuanlai Zheng, Guangzhou (CN); Feng Zhao, Guangzhou (CN); Dongmei Li, Guangzhou (CN)

(21) Appl. No.: 18/890,872

(22) Filed: Sep. 20, 2024

(30) Foreign Application Priority Data
Sep. 20, 2023 (CN) 202311213621.3

(51) Int. Cl. G01N 1/34; G01N 1/28; G01N 1/42

(52) U.S. Cl. CPC G01N 1/34; G01N 1/42; G01N 2001/2866; G01N 2001/2873

(57) ABSTRACT

A method for pretreatment of a biological sample for radionuclides measurement using gamma-spectroscopy includes the following steps: (1) subjecting the biological sample to washing, air-drying for surface water removal, and weighing to obtain a clean and dry sample, and grinding and pulping the clean and dry sample or cutting the clean and dry sample into sections to obtain a sample pulp or sample sections; (2) spraying the sample pulp or sample sections with liquid nitrogen for quick-freezing to obtain a frozen sample; (3) transferring the frozen sample into a vacuum lyophilizer, and lyophilizing the frozen sample to obtain a lyophilized sample; (4) collecting, weighing, grinding, and sieving the lyophilized sample to obtain a biological lyophilized powder; and (5) filling the biological lyophilized powder into a weighed sample box, tamping or compacting, sealing, and weighing to obtain a to-be-measured sample for the radionuclide measurement using gamma-spectroscopy.

### CROSS REFERENCE TO RELATED APPLICATIONS

The present application claims the benefit of Chinese Patent Application No. 202311213621.3 filed on Sep. 20, 2023, the contents of which are incorporated herein by reference in their entirety.

### TECHNICAL FIELD

The present disclosure relates to the technical field of nuclide measurement, and in particular to a method for pretreatment of a biological sample for radionuclide measurement using gamma-spectroscopy.

### BACKGROUND

The high-purity germanium (HPGe) γ spectroscopy analysis method is mainly as follows: a biological sample prepared into a specific geometric shape is placed at an appropriate position of a germanium detector of a spectroscopy system to acquire a γ spectrum of the biological sample and determine a full-energy peak position and a net peak area correspondingly, and then types of radionuclides in the biological sample and activity concentrations thereof are determined according to an energy calibration coefficient, a full-energy peak efficiency calibration coefficient, and a γ-ray emission probability of a γ spectrometer, a mass or volume of the biological sample, and relevant parameters or correction coefficients. The traditional method for pretreating a biological sample before undergoing radionuclide measurement generally includes the following steps: 1) sample preparation and oven-drying; 2) sample carbonization; 3) ashing; and 4) preparation of a to-be-measured sample and nuclide analysis. This method has the following disadvantages: 1) The pretreatment requires complicated operations such as oven-drying, carbonization, and ashing, which are time-consuming and laborious and cause heavy environmental pollution. 2) The high-temperature treatments are easy to cause a nuclide loss, or are not suitable for the direct measurement of volatile nuclides. 3) This method is not suitable for the treatment and measurement of special samples. 4) The more the pretreatment steps and the more complicated the process, the more uncertain factors affecting measurement results that are introduced during a pretreatment process and the greater the uncertainty of measurement results. 5) There are certain difficulties in the sample self-absorption correction method, which increases the uncertainty of results.

CN109239758A discloses a pretreating method of a biological sample for radionuclide measurement; the method is based on freeze-drying and compression molding, and mainly includes the following steps: (1) A biological sample is taken, thawed, weighed, and vacuum-lyophilized to obtain a lyophilized sample. (2) The lyophilized sample is ground for crushing and then sieved to obtain a biological lyophilized powder. (3) The biological lyophilized powder is molded with a mold and vacuum-packed to obtain a to-be-measured sample for radionuclide measurement using gamma-spectroscopy. The method has the following disadvantages: 1) The vacuum lyophilization in the pretreatment requires a harsh temperature condition and a long freezing time. 2) Before measuring, a mold is required to mold a biological lyophilized powder, which is cumbersome. Therefore, it is necessary to further improve a method for pretreating a biological sample before undergoing radionuclide measurement using gamma-spectroscopy.

### SUMMARY

An objective of the present disclosure is to overcome the deficiencies of the prior art and provide a method for pretreatment of a biological sample for radionuclide measurement using gamma-spectroscopy. The method involves simple steps, a high rate, and a low energy consumption, and is conducive to improving the accuracy of radionuclide measurement using gamma-spectroscopy for a biological sample.

To achieve the above objective, the present disclosure adopts the following technical solutions:

A method for pretreatment of a biological sample for radionuclide measurement using gamma-spectroscopy is provided, including the following steps:
(1) subjecting the biological sample to washing, air-drying for surface water removal, and weighing to obtain a clean and dry sample, and grinding and pulping the clean and dry sample or cutting the clean and dry sample into sections to obtain a sample pulp or sample sections;
(2) quick-freezing the sample pulp or sample sections with liquid nitrogen to obtain a frozen sample;
(3) transferring the frozen sample into a vacuum lyophilizer, and lyophilizing the frozen sample to obtain a lyophilized sample;
(4) grinding and sieving the lyophilized sample to obtain a biological lyophilized powder; and
(5) filling the biological lyophilized powder into a sample box, tamping or compacting, sealing, and weighing to obtain a to-be-measured sample for the radionuclide measurement using gamma-spectroscopy.

The present disclosure adopts a liquid-nitrogen quick-freezing+vacuum-lyophilization+grinding process to pretreat a biological sample, which can reduce a loss of nuclides to be measured and avoid the introduction of interferences and impurities. The biological lyophilized powder of the present disclosure can be filled in a sample box to allow the HPGe or sodium iodide (NaI(Tl)) radionuclide measurement using gamma-spectroscopy, which does not require compression molding, can allow the rapid relative measurement of radionuclides using gamma-spectroscopy, and is conducive to the simple, rapid, efficient, low-cost, environment-friendly, and scientifically-accurate measurement and analysis of radionuclides in a biological sample.

In contrast to the direct lyophilization treatment, the present disclosure adopts a liquid-nitrogen quick-freezing+lyophilization process to pretreat a biological sample, which does not require a special freezing device, greatly shortens a time of vacuum-lyophilization, and is conducive to improving a lyophilization rate and reducing the total energy consumption and the uncertainty of measurement results.

The present disclosure can adopt a gamma spectroscopy sourceless efficiency calibration method to conduct nuclide measurement and analysis for a to-be-measured sample, with a measurement time of no less than 24 h.

Preferably, in the step (2), the liquid nitrogen is sprayed for more than 60 s to allow the quick-freezing.

In the present disclosure, the frozen sample is rapidly transferred into the vacuum lyophilizer and then lyophilized directly without a pre-freezing stage, and a time of liquid nitrogen spray-based quick-freezing is optimized through tests to allow the rapid prefreezing of the biological sample, which shortens a pre-freezing time by at least 3 h to 5 h while ensuring a prominent freezing effect for the biological sample, greatly shortens a time of lyophilization, and is conducive to the rapid measurement of radionuclides using gamma-spectroscopy.

Preferably, in the step (5), a mass fraction of the water content in the to-be-measured sample is 8% to 10%. By controlling a water content in the to-be-measured sample, the biological sample can be effectively concentrated to improve quality of the subsequent to-be-measured sample.

Preferably, the lyophilization comprises a sublimation stage with a temperature of 40° C. to 60° C. and a vacuum degree of no more than 120 Pa, and the lyophilization is conducted for 5 h to 8 h. The present disclosure improves a lyophilization effect for the biological sample by optimizing lyophilization parameters, which is conducive to reducing the uncertainty of measurement results.

Preferably, in the step (4), the sieving is conducted with a 30-80 mesh sieve to obtain the biological lyophilized powder.

Preferably, in the step (5), the sample box is a Marlin cup. In the present disclosure, after undergoing liquid-nitrogen quick-freezing, lyophilization, and grinding, the biological sample is directly filled in the Marlin cup, compacted, and then measured, which can ensure the accuracy of a measurement result. It can be seen that the present disclosure can reduce the sample preparation and treatment steps on the basis of ensuring the accuracy of data, and reduce the error factors.

Preferably, the biological sample is one selected from fish, shrimp, shelled shellfish, poultry, and plant samples.
a. Fish: The fish can be the whole fish, or can be different parts of fish as needed, such as fish head, fish viscera, gutted fish, and boneless fish.
b. Shrimp: The shrimp can be the whole shrimp, or can be different parts of the shrimp as needed, such as shrimp head and shrimp meat.
c. Shelled shellfish including clams, mussels, oysters, or the like.
d. Poultry including chickens, ducks, geese, birds, or the like: The poultry can be the whole poultry with a feather removed, or can be different parts of the poultry as needed, such as poultry head, gutted poultry meat, and beheaded and gutted poultry meat.
e. Plant including algae, vegetables, bacteria, shrubs, trees, or the like: The plant can be the whole plant, or can be different parts of the plant as needed, such as leaves, flowers, fruits, roots, and stems.

The method of the present disclosure involves a simple process, a high rate, and a low energy consumption, and is suitable for the measurement of biological samples such as fish, shrimp, shelled shellfish, poultry, and plants.

Compared with the prior art, the present disclosure has the following beneficial effects:

The present disclosure adopts a liquid-nitrogen quick-freezing+lyophilization process to pretreat a biological sample, which can reduce a loss of nuclides to be measured and avoid the introduction of interferences and impurities. The biological lyophilized powder of the present disclosure can be filled in a sample box to allow the HPGe or sodium iodide (NaI(Tl)) radionuclide measurement using gamma-spectroscopy, which does not require compression molding, can allow the rapid relative measurement of radionuclides using gamma-spectroscopy, shortens a measurement time, improves a measurement efficiency, and is conducive to the simple, rapid, efficient, low-cost, environment-friendly, and scientifically-accurate measurement and analysis of radionuclides in a biological sample.

In contrast to the direct lyophilization treatment, the present disclosure adopts a liquid-nitrogen quick-freezing+lyophilization process to pretreat a biological sample, which does not require a special prefreezing device, greatly shortens a time of vacuum-lyophilization, and is conducive to improving a lyophilization rate and reducing the total energy consumption and the uncertainty of measurement results.

### DETAILED DESCRIPTION

In order to well illustrate the objectives, technical solutions, and advantages of the present disclosure, the present disclosure will be further described below in conjunction with specific embodiments. It should be understood by those skilled in the art that the specific embodiments described herein are merely intended to explain the present disclosure, rather than to limit the present disclosure.

In the embodiments, unless otherwise specified, the experimental methods used are conventional, and the materials and reagents used are commercially available.

A rapid method for pretreatment of a biological sample for radionuclide measurement using gamma-spectroscopy is provided, including the following steps:
(1) The biological sample is classified, washed, air-dried for surface water removal, and weighed to obtain a clean and dry sample, and then the clean and dry sample is ground and pulped or cut into sections to obtain a sample pulp or sample sections. If the water content in the clean and dry sample is high, the clean and dry sample is ground and pulped. If the water content in the clean and dry sample is low, the clean and dry sample cannot be easily ground and pulped, and thus the clean and dry sample is cut into small sections manually.
(2) The sample pulp or sample sections is/are quick-frozen with liquid nitrogen to obtain a frozen sample.
(3) The frozen sample is transferred into a vacuum lyophilizer, and lyophilized to obtain a lyophilized sample.
(4) The lyophilized sample is ground and sieved to obtain a biological lyophilized powder.
(5) The biological lyophilized powder is sampled evenly and filled into a sample box, tamped or compacted, and sealed to obtain a to-be-measured sample for the radionuclide measurement using gamma-spectroscopy.

The present disclosure can adopt a gamma spectroscopy sourceless efficiency calibration method to conduct nuclide measurement and analysis for a to-be-measured sample, with a measurement time of no less than 24 h.

In the present disclosure, in the step (2), the liquid nitrogen is sprayed for more than 60 s to allow the quick-freezing.

In the present disclosure, a time of liquid nitrogen spray-based quick-freezing is optimized through tests to allow the rapid pre-freezing of the biological sample, which greatly shortens a pre-freezing time while ensuring a prominent freezing effect for the biological sample, so as to allow the rapid measurement of radionuclides using gamma-spectroscopy.

In the present disclosure, in the step (5), a mass fraction of the water content in the to-be-measured sample is 8% to 10%. By controlling a water content in the to-be-measured sample, the biological sample can be effectively concentrated to improve a quality of the subsequent to-be-measured sample.

In the present disclosure, the lyophilization consists of a sublimation stage with a temperature of 40° C. to 60° C. and a vacuum degree of no more than 120 Pa, and the lyophilization is conducted for 5 h to 8 h. The present disclosure improves a lyophilization effect for the biological sample by optimizing lyophilization parameters, which is conducive to reducing the uncertainty of measurement results.

In the present disclosure, in the step (4), the sieving is conducted with a 30-80 mesh sieve to obtain the biological lyophilized powder.

In the present disclosure, in the step (5), the sample box is a Marlin cup. In the present disclosure, after undergoing liquid-nitrogen quick-freezing, lyophilization, grinding, and sieving, the biological sample does not need to be molded with a special mold, and is directly filled in the Marlin cup and then measured, which can ensure the accuracy of a measurement result. It can be seen that the present disclosure can reduce the sample preparation and treatment steps on the basis of ensuring the accuracy of data, and reduce the error factors.

In the present disclosure, the biological sample is selected from fish, shrimp, shelled shellfish, poultry, and plant samples.
a. Fish: The fish can be the whole fish, or can be different parts of fish as needed, such as fish head, fish viscera, gutted fish, and boneless fish.
b. Shrimp: The shrimp can be the whole shrimp, or can be different parts of the shrimp as needed, such as shrimp head and shrimp meat.
c. Shelled shellfish including clams, mussels, oysters, or the like.
d. Poultry including chickens, ducks, geese, birds, or the like: The poultry can be the whole poultry with a feather removed, or can be different parts of the poultry as needed, such as poultry head, gutted poultry meat, and beheaded and gutted poultry meat.
e. Plant including algae, vegetables, bacteria, shrubs, trees, or the like: The plant can be the whole plant, or can be different parts of the plant as needed, such as leaves, flowers, fruits, roots, and stems.

The method of the present disclosure involves a simple process, a high rate, and a low energy consumption, and is suitable for the measurement of biological samples such as fish, shrimp, shelled shellfish, poultry, and plants.

The present disclosure adopts a liquid-nitrogen quick-freezing+vacuum-lyophilization+grinding process to pretreat a biological sample, which can reduce a loss of nuclides to be measured and avoid the introduction of interferences and impurities. The biological lyophilized powder of the present disclosure can be filled in a sample box, compacted, and sealed to allow the HPGe or sodium iodide (NaI(Tl)) radionuclide measurement using gamma-spectroscopy, which does not require compression molding, can allow the rapid relative measurement of radionuclides using gamma-spectroscopy, and is conducive to the simple, rapid, efficient, low-cost, environment-friendly, and scientifically-accurate measurement and analysis of radionuclides in a biological sample.

In contrast to the direct lyophilization treatment, the present disclosure adopts a liquid-nitrogen quick-freezing+lyophilization process to pretreat a biological sample, and the biological sample can be directly lyophilized without a pre-freezing stage; which does not require a special freezing device, greatly shortens a time of vacuum-lyophilization, and is conducive to improving a lyophilization rate and reducing the total energy consumption and the uncertainty of measurement results.

### Example 1

As an example of the method for pretreatment of a biological sample for radionuclide measurement using gamma-spectroscopy of the present disclosure, a method for pretreatment of a biological sample for radionuclide measurement using gamma-spectroscopy in this example included the following steps:
(1) The biological sample was washed, air-dried for surface water removal, and weighed to obtain a clean and dry sample, and then the clean and dry sample was ground and pulped or cut into sections to obtain a sample pulp or sample sections.
(2) The sample pulp or sample sections was/were sprayed with liquid nitrogen for 70 s to allow quick-freezing to obtain a frozen sample.
(3) The frozen sample was transferred into a vacuum lyophilizer and then directly lyophilized without a pre-freezing stage to obtain a lyophilized sample. The lyophilization consisted of a sublimation stage with a temperature of 60° C. and a vacuum degree of no more than 120 Pa. The lyophilization was conducted for 5 h.
(4) The lyophilized sample was ground and crushed by a grinder with the lyophilized sample being prevented from absorbing water, and then sieved through a 30-80 mesh sieve to obtain a biological lyophilized powder.
(5) The biological lyophilized powder was filled evenly in a Marlin cup, tamped or compacted, and weighed to obtain a to-be-measured sample for the radionuclide measurement using gamma-spectroscopy.

The gamma spectroscopy sourceless efficiency calibration method was adopted to allow the HPGe radionuclide measurement using gamma-spectroscopy in the to-be-measured sample, with a measurement time of no less than 24 h. A gamma spectrometer equipped with sourceless efficiency calibration software was adopted for measurement. The sourceless efficiency calibration software included unique characterization parameters of a HPGe detector, and could be used in combination with energy spectroscopy analysis software. The qualitative analysis was conducted according to energy of γ rays emitted by a nuclide to be measured or a decay daughter thereof. The quantitative analysis was conducted according to an area of a characteristic peak of γ energy of a nuclide to be measured in a γ spectrum.

### Example 2

As an example of the method for pretreatment of a biological sample for radionuclide measurement using gamma-spectroscopy of the present disclosure, a method for pretreatment of a biological sample for radionuclide measurement using gamma-spectroscopy in this example included the following steps:
(1) The biological sample was washed, air-dried for surface water removal, and weighed to obtain a clean and dry sample, and then the clean and dry sample was ground and pulped or cut into sections to obtain a sample pulp or sample sections.
(2) The sample pulp or sample sections was/were sprayed with liquid nitrogen for 80 s to allow quick-freezing to obtain a frozen sample.
(3) The frozen sample was transferred into a vacuum lyophilizer and then directly lyophilized without a pre-freezing stage to obtain a lyophilized sample. The lyophilization consisted of a sublimation stage with a temperature of 60° C. and a vacuum degree of no more than 120 Pa. The lyophilization was conducted for 8 h.
(4) The lyophilized sample was ground and crushed by a grinder with the lyophilized sample being prevented from absorbing water, and then sieved through a 30-80 mesh sieve to obtain a biological lyophilized powder.
(5) The biological lyophilized powder was filled evenly in a sample box, tamped or compacted, sealed, and weighed to obtain a to-be-measured sample for the radionuclide measurement using gamma-spectroscopy.

The gamma spectroscopy sourceless efficiency calibration method was adopted to allow the HPGe radionuclide measurement using gamma-spectroscopy in the to-be-measured sample, with a measurement time of no less than 24 h. A gamma spectrometer equipped with sourceless efficiency calibration software was adopted for measurement. The sourceless efficiency calibration software included unique characterization parameters of a HPGe detector, and could be used in combination with energy spectroscopy analysis software. The qualitative analysis was conducted according to energy of γ rays emitted by a nuclide to be measured or a decay daughter thereof. The quantitative analysis was conducted according to an area of a characteristic peak of γ energy of a nuclide to be measured in a γ spectrum.

### Example 3

As an example of the method for pretreatment of a biological sample for radionuclide measurement using gamma-spectroscopy of the present disclosure, a method for pretreatment of a biological sample for radionuclide measurement using gamma-spectroscopy in this example included the following steps:
(1) The biological sample was washed, air-dried for surface water removal, and weighed to obtain a clean and dry sample, and then the clean and dry sample was ground and pulped or cut into sections to obtain a sample pulp or sample sections.
(2) The sample pulp or sample sections was/were sprayed with liquid nitrogen for 90 s to allow quick-freezing to obtain a frozen sample.
(3) The frozen sample was transferred into a vacuum lyophilizer and then directly lyophilized without a pre-freezing stage to obtain a lyophilized sample. The lyophilization consisted of a sublimation stage with a temperature of 50° C. and a vacuum degree of no more than 120 Pa. The lyophilization was conducted for 6 h.
(4) The lyophilized sample was ground and crushed by a grinder with the lyophilized sample being prevented from absorbing water, and then sieved through a 30-80 mesh sieve to obtain a biological lyophilized powder.
(5) The biological lyophilized powder was filled evenly in a Marlin cup, tamped or compacted, sealed, and weighed to obtain a to-be-measured sample for the radionuclide measurement using gamma-spectroscopy.

The gamma spectroscopy sourceless efficiency calibration method was adopted to allow the HPGe radionuclide measurement using gamma-spectroscopy in the to-be-measured sample, with a measurement time of no less than 24 h. A gamma spectrometer equipped with sourceless efficiency calibration software was adopted for measurement. The sourceless efficiency calibration software included unique characterization parameters of a HPGe detector, and could be used in combination with energy spectroscopy analysis software. The qualitative analysis was conducted according to energy of γ rays emitted by a nuclide to be measured or a decay daughter thereof. The quantitative analysis was conducted according to an area of a γ spectral peak of a nuclide to be measured in a γ spectrum.

### Example 4

As an example of the method for pretreatment of a biological sample for radionuclide measurement using gamma-spectroscopy of the present disclosure, a method for pretreatment of a biological sample for radionuclide measurement using gamma-spectroscopy in this example included the following steps:
(1) The biological sample was washed, air-dried for surface water removal, and weighed to obtain a clean and dry sample, and then the clean and dry sample was ground and pulped or cut into sections to obtain a sample pulp or sample sections.
(2) The sample pulp or sample sections was/were sprayed with liquid nitrogen for 65 s to allow quick-freezing to obtain a frozen sample.
(3) The frozen sample was transferred into a vacuum lyophilizer and then lyophilized to obtain a lyophilized sample. The lyophilization consisted of a sublimation stage with a temperature of 40° C. and a vacuum degree of no more than 120 Pa. The lyophilization was conducted for 8 h.
(4) The lyophilized sample was ground and crushed by a grinder with the lyophilized sample being prevented from absorbing water, and then sieved through a 30-80 mesh sieve to obtain a biological lyophilized powder.
(5) The biological lyophilized powder was filled evenly in a Marlin cup, tamped or compacted, sealed, and weighed to obtain a to-be-measured sample for the radionuclide measurement using gamma-spectroscopy.

The gamma spectroscopy sourceless efficiency calibration method was adopted to allow the HPGe radionuclide measurement using gamma-spectroscopy in the to-be-measured sample, with a measurement time of no less than 24 h. A gamma spectrometer equipped with sourceless efficiency calibration software was adopted for measurement. The sourceless efficiency calibration software included unique characterization parameters of a HPGe detector, and could be used in combination with energy spectroscopy analysis software. The qualitative analysis was conducted according to energy of γ rays emitted by a nuclide to be measured or a decay daughter thereof. The quantitative analysis was conducted according to an area of a characteristic peak of γ energy of a nuclide to be measured in a γ spectrum.

A mass fraction of the water content of a biological sample produced after the liquid nitrogen quick-freezing+vacuum lyophilization in the present disclosure is 8% to 10%, and a water content of a sample produced after the ordinary oven-drying is generally about 12%. Compared with a sample produced after direct vacuum-lyophilization, a sample produced after the liquid nitrogen quick-freezing+vacuum lyophilization in the present disclosure has a high porosity, is easily crushed to obtain a homogeneous sample, and can ensure the accuracy of measurement without compression molding subsequently.

In the present disclosure, the biological sample is one selected from fish, shrimp, shelled shellfish, poultry, and plant samples.
a. Fish: The fish can be the whole fish, or can be different parts of fish as needed, such as fish head, fish viscera, gutted fish, and boneless fish.
b. Shrimp: The shrimp can be the whole shrimp, or can be different parts of the shrimp as needed, such as shrimp head and shrimp meat.
c. Shelled shellfish including clams, mussels, oysters, or the like.
d. Poultry including chickens, ducks, geese, birds, or the like: The poultry can be the whole poultry with a feather removed, or can be different parts of the poultry as needed, such as poultry head, gutted poultry meat, and beheaded and gutted poultry meat.
e. Plant including algae, vegetables, bacteria, shrubs, trees, or the like: The plant can be the whole plant, or can be different parts of the plant as needed, such as leaves, flowers, fruits, roots, and stems.

### Comparative Example 1

A method for pretreatment of a biological sample for radionuclide measurement using gamma-spectroscopy in this comparative example included the following steps:
(1) The biological sample was washed, air-dried for surface water removal, and weighed to obtain a clean and dry sample, and then the clean and dry sample was ground and pulped or cut into sections to obtain a sample pulp or sample sections.
(2) The sample pulp or sample sections was/were transferred into a vacuum lyophilizer and then lyophilized to obtain a lyophilized sample. The lyophilization was conducted for 20 h with a freezing temperature of −50° C., a drying temperature of 50° C., and a vacuum degree of no more than 120 Pa.
(3) The lyophilized sample was ground and crushed by a grinder with the lyophilized sample being prevented from absorbing water, and then sieved through a 30-80 mesh sieve to obtain a biological lyophilized powder. A dry-to-fresh ratio of the biological sample was calculated.
(4) The biological lyophilized powder was compression-molded by a mold with a shape matching a shape of the Marlin cup to obtain a molded sample, where a molding pressure was 50 t and a pressure was held for 3 h.
(5) The molded sample was placed in a vacuum-packing machine and vacuum-packed with the molded sample being prevented from absorbing water to obtain a to-be-measured sample for the radionuclide measurement using gamma-spectroscopy.

The gamma spectroscopy sourceless efficiency calibration method was adopted to allow the HPGe radionuclide measurement using gamma-spectroscopy in the to-be-measured sample produced after the compression-molding, with a measurement time of no less than 24 h. A gamma spectrometer equipped with sourceless efficiency calibration software was adopted for measurement. The sourceless efficiency calibration software included unique characterization parameters of a HPGe detector, and could be used in combination with energy spectroscopy analysis software. The qualitative analysis was conducted according to energy of γ rays emitted by a nuclide to be measured or a decay daughter thereof. The quantitative analysis was conducted according to an area of a γ spectral peak of a nuclide to be measured in a γ spectrum.

Finally, it should be noted that the above examples are provided merely to describe the technical solutions of the present disclosure, rather than to limit the protection scope of the present disclosure. Although the present disclosure is described in detail with reference to preferred examples, a person of ordinary skill in the art should understand that modifications or equivalent replacements may be made to the technical solutions of the present disclosure without departing from the spirit and scope of the technical solutions of the present disclosure.

1. A method for pretreatment of a biological sample for radionuclide measurement using gamma-spectroscopy, comprising the following steps:
(1) subjecting the biological sample to washing, air-drying for surface water removal, and weighing to obtain a clean and dry sample, and grinding and pulping the clean and dry sample or cutting the clean and dry sample into sections to obtain a sample pulp or sample sections;
(2) quick-freezing: spraying the sample pulp or sample sections with liquid nitrogen for quick-freezing to obtain a frozen sample;
(3) lyophilization: transferring the frozen sample into a vacuum lyophilizer, vacuuming at a temperature of −30° C. or lower, and lyophilizing the frozen sample to obtain a lyophilized sample;
(4) collecting, weighing, grinding, and sieving the lyophilized sample to obtain a biological lyophilized powder; and
(5) filling the biological lyophilized powder into a weighed sample box, tamping or compacting, sealing, and weighing to obtain a to-be-measured sample for the radionuclide measurement using gamma-spectroscopy.

2. The method of claim 1, wherein in the step (2), the liquid nitrogen is sprayed for more than 60 s to allow the quick-freezing.

3. The method of claim 1, wherein in the step (5), a mass fraction of the water content in the to-be-measured sample for the radionuclide measurement using gamma-spectroscopy is 8% to 10%.

4. The method of claim 1, wherein the lyophilization comprises a sublimation stage with a temperature of 40°° C. to 60° C. and a vacuum degree of no more than 120 Pa, and the lyophilization is conducted for 5 h to 8 h.

5. The method of claim 1, wherein in the step (4), the sieving is conducted with a 30-80 mesh sieve to obtain the biological lyophilized powder.

6. The method of claim 1, wherein in the step (5), the sample box is a Marlin cup.

7. The method of claim 1, wherein the biological sample is one selected from fish, shrimp, shelled shellfish, poultry, and plant samples.

8. The method of claim 2, wherein the biological sample is one selected from fish, shrimp, shelled shellfish, poultry, and plant samples.

9. The method of claim 3, wherein the biological sample is one selected from fish, shrimp, shelled shellfish, poultry, and plant samples.

10. The method of claim 4, wherein the biological sample is one selected from fish, shrimp, shelled shellfish, poultry, and plant samples.

11. The method of claim 5, wherein the biological sample is one selected from fish, shrimp, shelled shellfish, poultry, and plant samples.

12. The method of claim 6, wherein the biological sample is one selected from fish, shrimp, shelled shellfish, poultry, and plant samples.
